(19) United States
(12) Patent Application Publication
(10) Pub. No.: US 2007/0229810 A1
(43) Pub. Date: Oct. 4, 2007

(54) Illuminating method in paint defect detecting machine

(75) Inventor: Toshiyuki Kaya, Hiroshima-shi (JP)

Correspondence Address: KRATZ, QUINTOS & HANSON, LLP, 1420 K Street, N.W., Suite 400, WASHINGTON, DC, 20005, US

(73) Assignee: CHUO ELECTRONIC MEASUREMENT CO., LTD., Hiroshima-shi (JP)

(21) Appl. No.: 11/727,035

(22) Filed: Mar. 23, 2007

(30) Foreign Application Priority Data
Apr. 3, 2006 (JP) 2006-101507

(51) Int. Cl. G01N 21/88

(52) U.S. Cl. 356/237.2

(57) ABSTRACT

To develop and provide an illuminating method for a paint defect detecting machine in which a camera section and an illumination section are provided on an integral base board to optimize the illuminating method for multiple curved surface areas of a vehicle body, thereby to minimize undetectable areas and increase areas detectable by the apparatus, whereby areas of inspection by the human eye are reduced to implement labor saving. An illuminating method for handling multiple curved surfaces in the paint defect detecting machine is configured such that an illumination section and a CCD camera section are integrated within a same base board; and the illumination section is configured such that high luminance LEDs are linearly arranged into a stripe form at fixed width interval, thereby to enable arrangement of the LEDs mounted onto the base board such that the distance to a coated surface from the center of a camera view field is the same as that from a CCD camera mounted in the center of the base board, wherein an integral unit of the illumination section formed from the thus arranged LEDs and the CCD camera(s) is moved by a robot unit such that the coated surface and the CCD camera are located perpendicular to each other.

### BACKGROUND OF THE INVENTION

1. Field of the Invention

The present invention relates to an illuminating method in a paint defect detecting machine usable for multiple curved surfaces of a vehicle body.

2. Description of the Related Art

Hitherto, means for detecting a coated surface of a vehicle body by using an image processing apparatus is provided. It has already been verified that an illumination section for image capturing by using an imaging camera in the field of image processing techniques in a coating inspection apparatus is configured in a manner that recently developed high luminance LEDs are arranged into a honeycomb shape, and the effect of causing a defect to “float from peripheral illumination” is very effective, such as disclosed in, for example, Japanese Patent Application Laid-Open Nos. 2004-198403, 2005-291842, 2005-291843, 2005-291844, 2005-148047, 2005-291845, 2005-315841, 2006-184080 and 2006-343185.

However, in multiple curved surface areas of a vehicle body (especially multiple curved surface areas on the same screen of a camera view field), reflected illumination light (honeycomb-shaped LED illumination) approaches, or a defect and illumination assimilate with one another, thereby resulting in overlooking of the defect (refer to FIG. 5). As a result, the area is recognized to be an undetectable area.

Accordingly, on the basis of the related prior arts disclosed in Japanese Patent Application Laid-Open Nos. 2004-198403, 2005-291842, 2005-291843, 2005-291844, 2005-148047, 2005-291845, 2005-315841, 2006-184080 and 2006-343185, the present invention is to develop and provide an illuminating method for a paint defect detecting machine in which a camera section and an illumination section are provided on a same base board to thereby optimize the illuminating method for multiple curved surface areas of a vehicle body (especially multiple curved surface areas on the same screen of a camera view field), that is, arrangement of same units is changed, thereby to solve the problems in the manner that undetectable areas are minimized and areas detectable by the apparatus are increased, whereby areas for human-eye detection are reduced and labor saving is implemented.

### SUMMARY OF THE INVENTION

According to one aspect of the present invention, there is provided an illuminating method which is usable for coating inspection of multiple curved surfaces of a vehicle, and a paint defect detecting machine therefor, in which high luminance light emitting devices (LEDs) are used as light emitting elements and the respective high luminance LEDs are arranged linearly and in plural rows such that cameras and illuminations in an image processing apparatus mounted to an end of a robot can be used for multiple curved surfaces of a vehicle body, and that optimal image processing can be performed corresponding to all coating colors, types of coated surfaces, levels of brightness, and types of defects.

According to the present invention, 95% or larger detection area of the overall coated surface of the vehicle body is secured, and the areas of inspection by the human eye in the conventional manner are minimized, thereby to provide significant labor saving effects. Further, the components are angularly arranged to enable handling, especially, multiple curved surfaces presented within the same curved surface as the camera view field of the image processing apparatus, so that illuminance attenuation can be suppressed. Moreover, very advantageous effects are exhibited in that, for example, optimal image processing can be performed for all coating colors, types of coated surfaces, levels of brightness, and types of defects.

### BRIEF DESCRIPTION OF THE DRAWINGS

FIG. 1A and FIG. 1B are views showing an illumination unit for use in the present invention, in which FIG. 1A is a front view and FIG. 1B is a plan view;

FIG. 2 is a front view showing details of the illumination unit for use in the present invention;

FIG. 3A and FIG. 3B are views showing details of the illumination unit for use in the present invention, in which FIG. 3A is a front view and FIG. 3B is a side view;

FIG. 4 is a block diagram showing the entirety of a paint defect detecting machine of the present invention; and

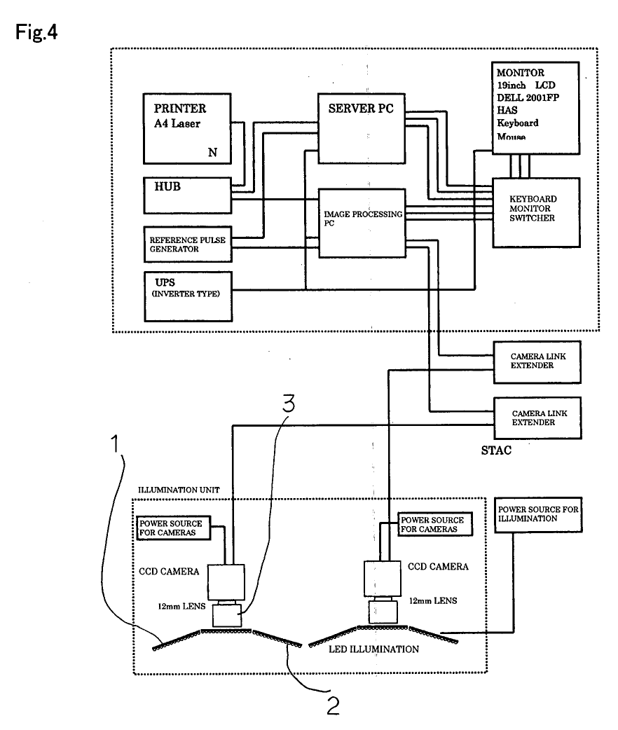

FIG. 5 is a perspective view showing a conventional LED arrangement state.

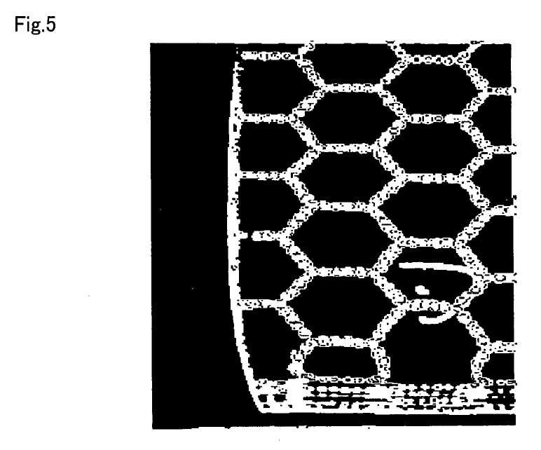

### DESCRIPTION OF THE PREFERRED EMBODIMENT

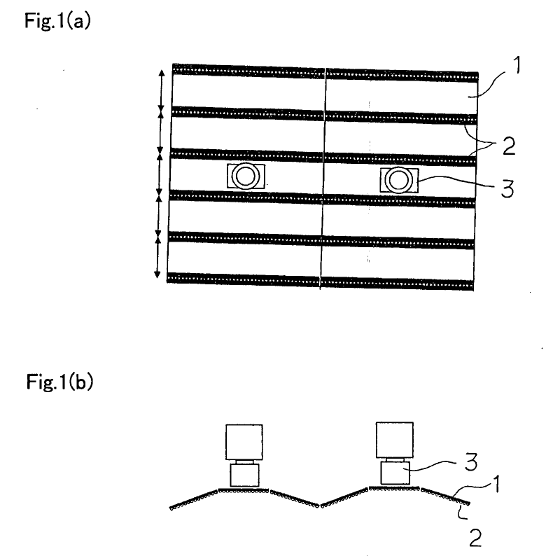

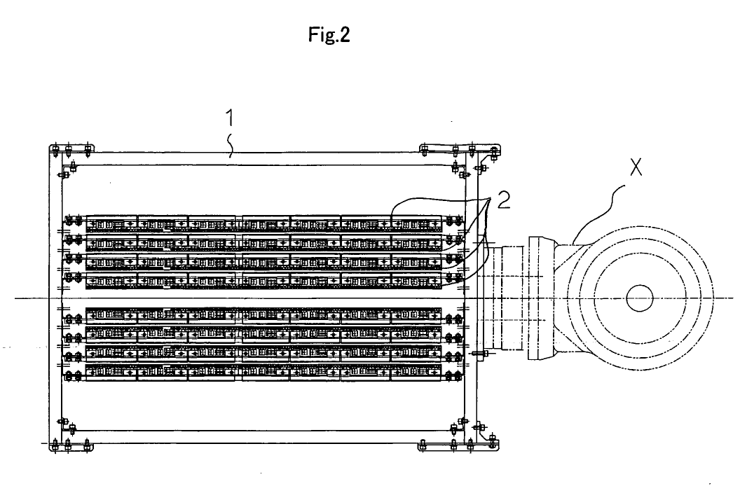

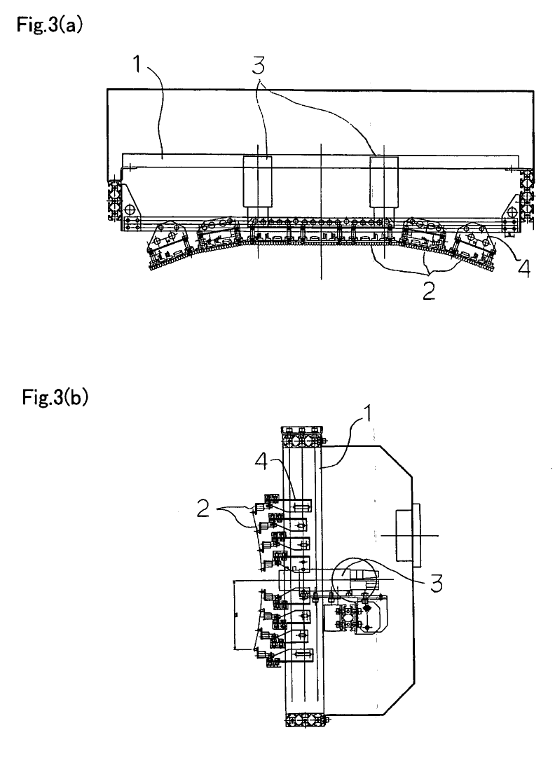

An apparatus for use in a preferred embodiment of the present invention will be described in detail. FIG. 1 and FIG.2 show an LED illumination section and camera section of a paint defect detecting machine according to the present invention. The overall configuration of the paint defect detecting machine is shown in a block diagram of FIG. 3.

An illumination unit is fitted to a robot arm. A processing method after processes with the LED illumination section and camera section is performed by a system that is substantially the same as that disclosed in any one of Patent Documents listed above.

The principle of the present invention is the use of a base board integrally having the LED illumination section and CCD camera section of an image processing apparatus mounted to an end of a robot to be one unit. The unit is operated by a robot as follows:

1) The unit is located at a right angle to a coated surface;

2) The distance between the unit and the coated surface is kept constant; and

3) The unit moves at a fixed speed relative to the coated surface.

In the present invention, the illumination section is modified to deal with, especially, multiple curved surfaces presented in the same screen of the camera view field, as follows:

4) Honeycomb type arrangement is made to be a stripe type arrangement having a certain interval; and

5) Round type LEDs are arranged to respectively have the fixed distance to the coated surface from the center of the camera view field.

The unit according to above items 4) and 5) is operated by the robot such that the movement direction of the camera and illumination section over the coated surface is perpendicular thereto.

### EMBODIMENT

An illuminating method in the paint defect detecting machine of the present invention will now be described in detail hereinbelow with reference to the drawings. An illuminating method for handling multiple curved surfaces in a paint defect detecting machine in the event of inspection of a coating inspection defect of a vehicle by using the paint defect detecting machine in accordance with an image processing technique is characterized in that the illumination section and CCD camera section are integrated within a same base board (1); and the illumination section is configured such that high luminance LEDs (2) are linearly arranged into a stripe form at fixed width interval, thereby to enable arrangement of the LEDs. (2) mounted onto the base board (1) such that the distance to a coated surface from the center of a camera view field is the same as that from a CCD camera (3) provided in the center of the base board, wherein an integrated unit of an illumination section formed from the thus arranged LEDs (2) and the CCD camera(s) (3) is moved by a robot unit (X) such that the coated surface and the CCD camera (3) are located perpendicular to each other.

The configuration is formed in the manner that the high luminance LEDs (2) linearly arranged into the stripe form are fitted to brackets (4) in units of plural pieces, and the brackets (4) are mounted projectively movable along the forward direction, in which the entirety of the high luminance LEDs (2) is arcuately bent.

In the case where the illuminating method for the paint defect detecting machine is established, and the apparatus is actually manufactured and used, the present invention has industrial usability.

What is claimed is:

1. An illuminating method for handling multiple curved surfaces in a paint defect detecting machine in the event of inspection of a coating defect inspection of a vehicle by using the paint defect detecting machine in accordance with an image processing technique, the method comprising the steps of:
being configured such that an illumination section and a CCD camera section are integrated within a same base board, the illumination section being configured such that high luminance LEDs are linearly arranged into a stripe form at fixed width interval,
being enable arrangement of the LEDs mounted onto the base board such that the distance to a coated surface from the center of a camera view field is the same as that from the CCD camera provided in the center of the base board, and
moving an integral unit of the illumination section formed from the thus arranged LEDs and the CCD camera(s) by a robot unit such that the coated surface and the CCD camera are located perpendicular to each other.
